(19) United States
(12) Patent Application Publication
(10) Pub. No.: US 2026/0292568 A1
(43) Pub. Date: Sep. 24, 2026

(54) METHODS OF LATENCY MEASUREMENT, LATENCY REPORT AND CORRESPONDING TRANSMISSION RECONFIGURATION

(71) Applicant: MEDIATEK INC., Hsinchu City (TW)

(72) Inventors: Jing-Wei CHEN, Hsinchu City (TW); Nathan Edward TENNY, San Jose, CA (US); Tao CHEN, Beijing (CN)

(73) Assignee: MEDIATEK INC., Hsinchu City (TW)

(21) Appl. No.: 19/472,999

(22) PCT Filed: Oct. 18, 2024
(86) PCT No.: PCT/CN2024/125666

§ 371 Date: Oct. 6, 2025

(30) Foreign Application Priority Data
Oct. 31, 2023 (WO) PCT/CN2023/128472

(51) Int. Cl. H04W 24/10; H04W 24/08

(52) U.S. Cl. CPC H04W 24/10; H04W 24/08

(57) ABSTRACT

In an aspect of the disclosure, a method, a computer-readable medium, and an apparatus are provided. The method may be performed by a UE. In certain configurations, the UE receives a plurality of packets from a forwarding station. The forwarding station is a source station of a network or a connecting relay node, and the UE functions as a destination station or a relay node. The UE performs latency measurement on the packets according to a latency measurement configuration to obtain latency of the packets. The UE generates a latency measurement report with the latency of the packets measured, and transmits the latency measurement report to one or more report receiving stations according to a latency report configuration. Upon receiving the latency measurement report, the report receiving stations may perform transmission reconfiguration.

### CROSS-REFERENCE TO RELATED APPLICATION(S)

This application claims the benefits of PCT Application Number PCT/CN2023/128472, entitled “METHODS OF LATENCY MEASUREMENT, LATENCY REPORT AND CORRESPONDING TRANSMISSION RECONFIGURATION” and filed on Oct. 31, 2023, which is expressly incorporated by reference herein in their entirety.

### TECHNICAL FIELD

The present disclosure relates generally to communication systems, and more particularly, to techniques of methods and apparatuses of latency measurement, latency report and corresponding transmission reconfiguration.

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method may be performed by a UE. In certain configurations, the UE receives a plurality of packets from a forwarding station. The forwarding station is a source station of a network or a connecting relay node, and the UE functions as a destination station or a relay node. The UE performs latency measurement on the packets according to a latency measurement configuration to obtain latency of the packets. The UE generates a latency measurement report with the latency of the packets measured, and transmits the latency measurement report to one or more report receiving stations according to a latency report configuration.

In another aspect of the disclosure, a method, a computer-readable medium, and an apparatus are provided. The method may be performed by a source station of a network. In certain configurations, the source station transmits a plurality of packets to a UE or a relay node. The source station receives a latency measurement report from the UE or the relay node. In response to receiving the latency measurement report, the source station performs transmission reconfiguration according to the latency measurement report.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an example procedure of a UE connected to a source station in a tethering scenario.

FIG. 8 is a diagram illustrating an example procedure of a UE connected to a source station via multiple relay nodes in a mesh/multi-hop scenario.

FIG. 9 is a diagram illustrating an example procedure of a UE connected to a source station via relay nodes with per link, per link set and per path latency.

FIG. 10 is a diagram illustrating an example procedure of performing latency measurement per packet.

FIG. 11 is a diagram illustrating an example procedure of performing latency measurement periodically on the packets.

FIG. 12 is a diagram illustrating an example procedure of performing latency measurement using a timestamp in each packet.

FIG. 13 is a diagram illustrating an example procedure of performing latency measurement by recording the packet transmission latency.

FIG. 14 is a diagram illustrating an example procedure of performing latency measurement by the timestamp in a single hop scenario, where the hopping node is synchronized to the source station and the destination station individually by local link clock source.

FIG. 15 is a diagram illustrating an example procedure of performing latency measurement by the timestamp in a multi-hop scenario, where the hopping nodes are synchronized by unified timestamps.

FIG. 16 is a diagram illustrating an example procedure of performing latency measurement by the timestamp in a multi-hop scenario, where per link set latency is measured.

FIG. 17 is a diagram illustrating an example procedure of performing latency measurement by the self-recorded packet transmission delay in a tethering scenario.

FIG. 18 is a diagram illustrating an example procedure of a UE transmitting the latency measurement report periodically.

FIG. 19 is a diagram illustrating an example procedure of a UE transmitting the latency measurement report by a triggering event.

FIG. 20 is a diagram illustrating an example procedure of a destination station performing the latency measurement and transmitting the latency measurement report.

FIG. 21 is a diagram illustrating an example procedure of a source station performing transmission reconfiguration upon receipt of the latency measurement report.

FIG. 22 is a flow chart of a method (process) for wireless communication of a UE.

FIG. 23 is a flow chart of a method (process) for wireless communication of a source station of a network.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

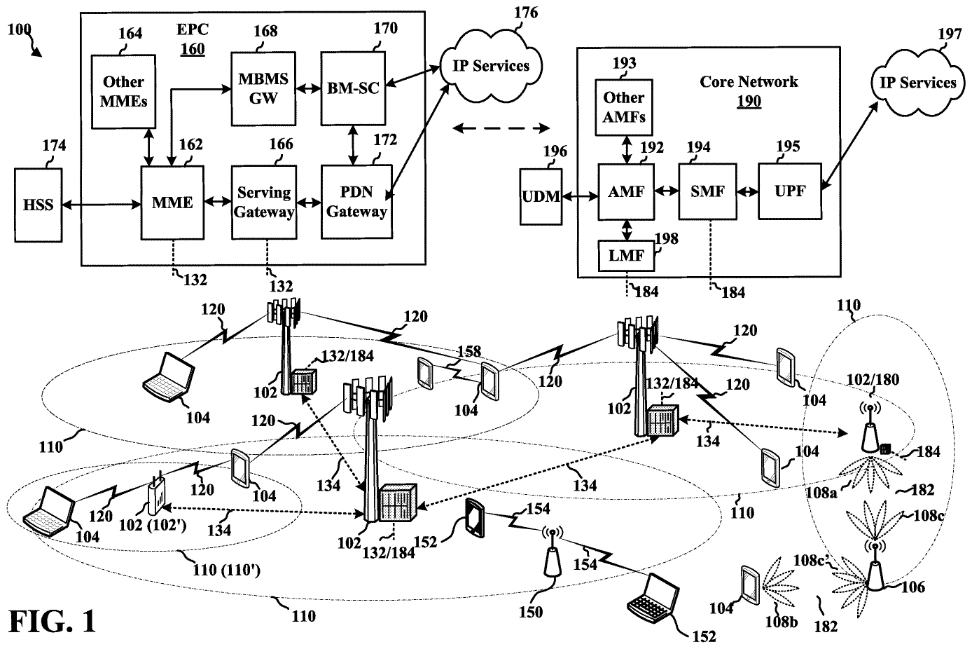

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

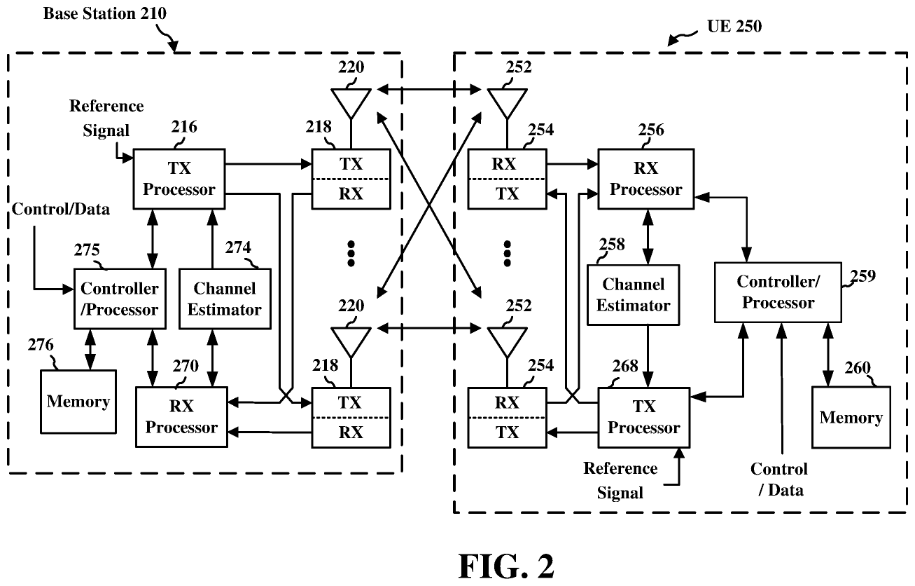

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

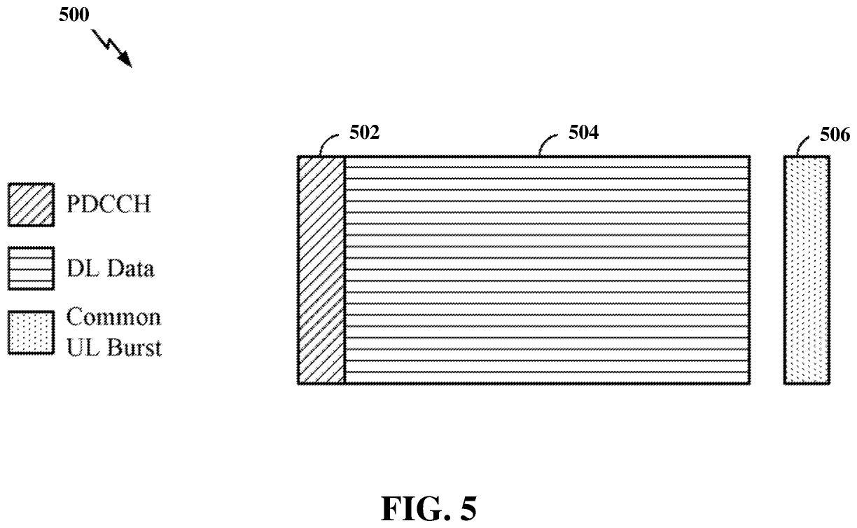

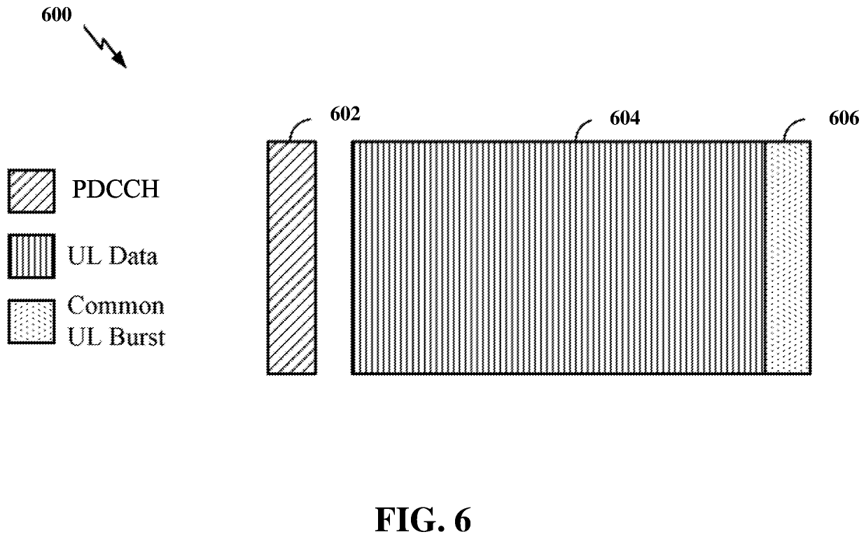

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

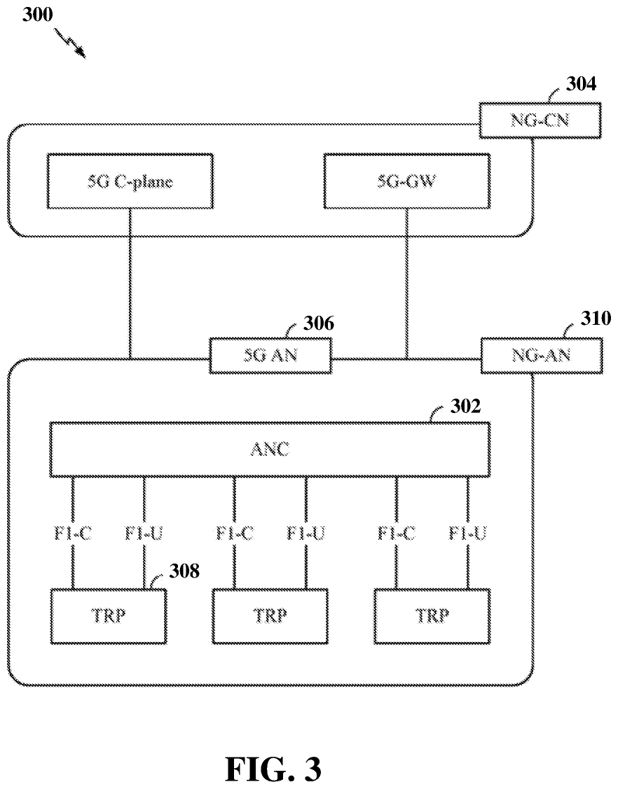

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

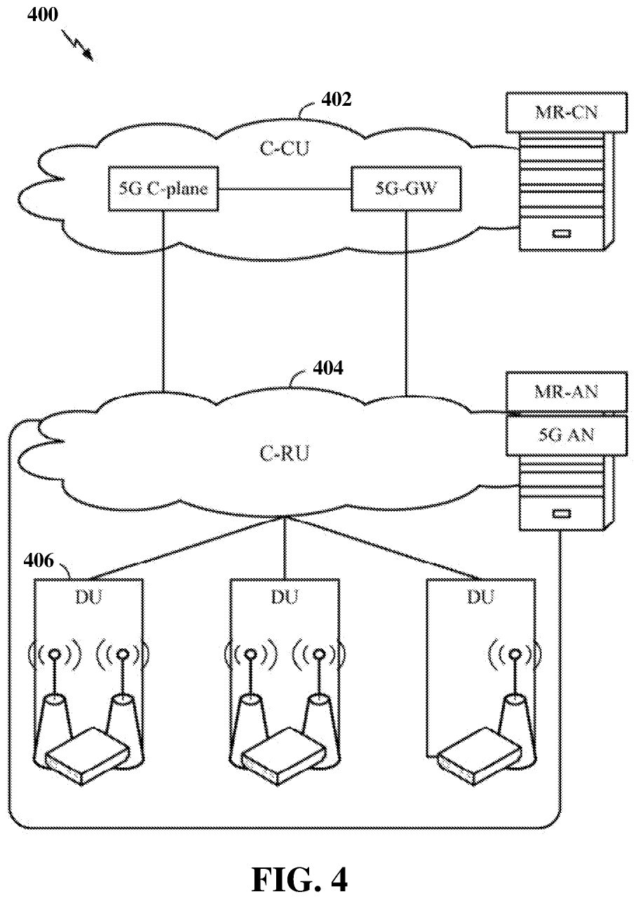

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

One of a trend of network deployment toward B5G/6G is supporting distributed architecture. A source station may serve its destination station through one or multiple hopping relay nodes, which increases challenges on traffic quality of service (QoS) control. Therefore, UE-assisted latency measuring, reporting and corresponding transmission reconfiguration are the approach for the system to comply with traffic QoS requirement and packet delay budget (PDB) for the potential network deployments.

In certain configurations, the packet transmission latencies between the relay nodes and the destination station are unknown to the source station. The uncertainty of packet transmission latency is largely increased by hopping nodes and corresponding packet routing algorithm in different scenarios. The packet latency uncertainty causes violation on packet delay budget (PDB) and potential QoS requirement. Referring to the 3GPP specification (e.g., 3GPP TR 38.838), the PDB is defined as the tolerable transmission delay for a packet, which is one of major performance KPI for XR services. As a result, the difficulties of network scheduling, link adaptation, rate adaptation and network topology planning are increased. Therefore, certain aspects of the disclosure relate to methods and apparatuses of performing latency measurement, providing latency report and corresponding transmission reconfiguration in different scenarios. If a packet latency report is provided to by the relay node and/or the destination station, a better transmission assignment to the destination station may be achieved, including adaptive scheduling, link adaptation, path selection/switching decision and routing decision. Specifically, for low latency traffic serving through multi-path, multi-hop, or potential 6G mesh and distributed network deployment, the methods and apparatuses proposed may provide a general solution with multiple alternatives on latency measurement and reporting methodologies. In certain configurations, the latency measurement of a (pre-)configured measuring link/link set/path and timing may be performed based on a timestamp inserted in the adaptation layer, the PDCP layer, or other transport layer in user plane. The latency measurement may be performed on a control packet and/or a data packet. The packet latencies measured by relay node and/or destination station are further derived into reporting value with various formats. The measured latency is included in the latency measurement report, which may include the latency of per link/link set/path packet transmission, and/or information of the activation of tethering mode, and/or estimation of per link/link set/path average throughput. The latency measurement report may be distributed to connecting stations or the source station, and the timing and/or period for the reporting may be (pre-)configured. Upon reception of the latency measurement report, the transmission reconfiguration/adaptation takes place, including codec rate adaptation and/or link adaptation and/or adaptive scheduling and/or path switching and/or routing decision. The transmission reconfiguration of a station/node may be performed proactively under a decentralized network topology or performed reactively under a centralized topology.

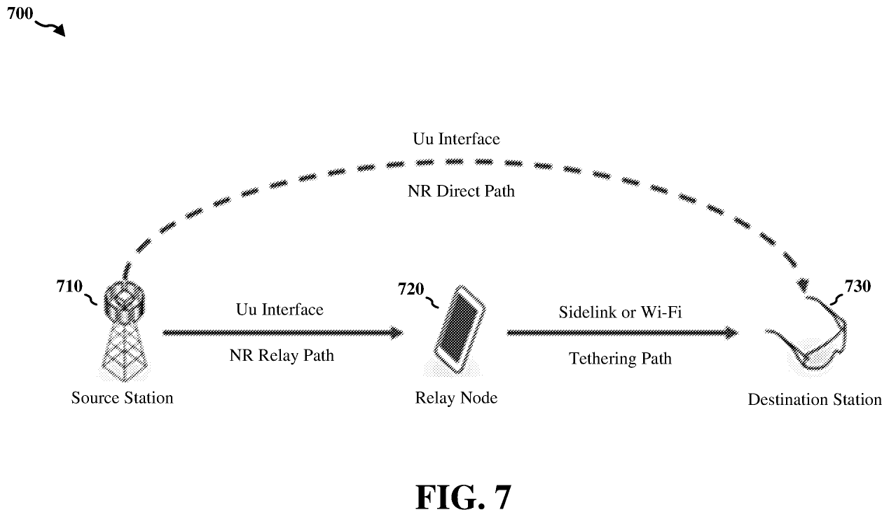

FIG. 7 is a diagram illustrating an example procedure of a UE connected to a source station in a tethering scenario. Specifically, the procedure 700 shows a tethering topology in which a destination station 730 (e.g., a UE) is served by a source station 710 (e.g., a base station or gNB) through a tethering path and a direct path. When the tethering link is enabled, the source station 710 (e.g., gNB) transmits packets to a relay node 720 (e.g., another UE) on the relay path through a Universal Mobile Telecommunications System (UMTS) air interface (which is also known as the “Uu interface”), and the relay node 720 forwards the packets to the destination station 730 on the tethering path. When the direct link is enabled, the source station 710 may transmit the packets directly on the direct path through the Uu interface.

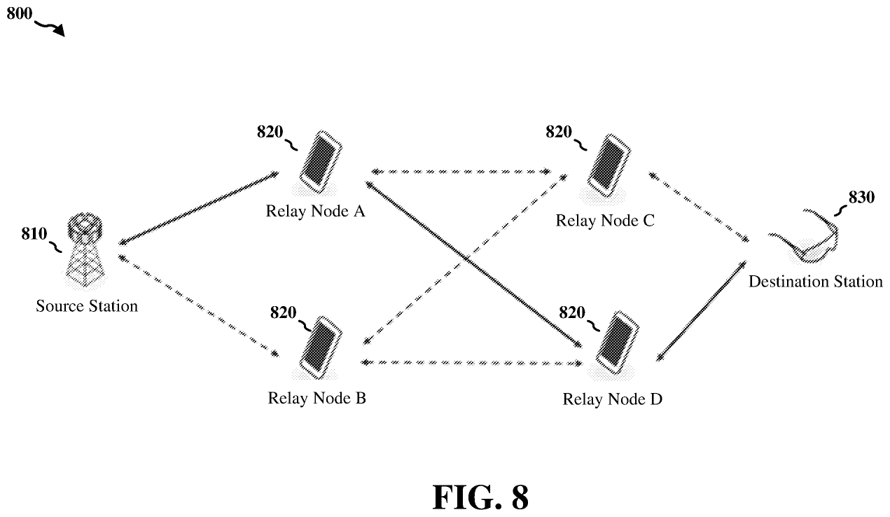

FIG. 8 is a diagram illustrating an example procedure of a UE connected to a source station via multiple relay nodes in a mesh/multi-hop scenario. Specifically, the procedure 800 shows a mesh topology, which enables future B5G/6G mesh deployment with IIoT or ambient IoT or V2X. In the procedure 800, multiple tools, devices or vehicles are linked with each other to construct a mesh topology, where one of the devices serves as gateway/central control device to connect other devices to network and to distribute computing tasks/sensing tasks/movement instruction to the connected devices.

As shown in FIG. 8, under the mesh/multi-hop topology, multiple relay nodes 820 (e.g., UEs), including relay nodes A, B, C and D, are provided between the source station 810 (e.g., a base station or gNB) and the destination station 830 (e.g., a UE). Specifically, the source station 810 transmits a packet to the relay node A, and the relay node A forwards the packet to the relay node C or the relay node D until the packet is arrived at the destination station 830. The source station 810 may also transmit a packet to the relay node B, and the relay node B forwards the packet to the relay node C or the relay node D until the packet is arrived at the destination station. In this case, the mesh/multi-hop topology allows multiple packet transmission routes between the source station 810 and the destination station 830.

In certain configurations, in the procedures 800 or 900, the source station (e.g., gNB 810 or 910) may configure the latency measurement and the latency reporting of the UEs (e.g., the relay nodes 820 or 920 or the destination stations 830 or 930) in each scenario, such that each UE may perform corresponding latency measurement and generate corresponding latency measurement report for the source station and other relay nodes. Thus, the source station (and in some cases, the relay nodes) may perform transmission reconfiguration upon receiving the latency measurement report.

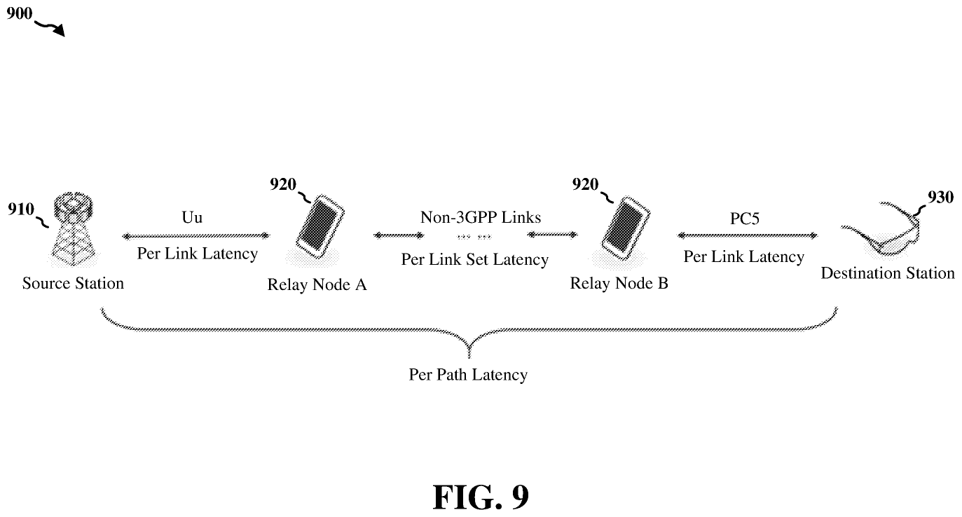

FIG. 9 is a diagram illustrating an example procedure of a UE connected to a source station via relay nodes with per link, per link set and per path latency. As shown in FIG. 9, multiple relay nodes 920 (e.g., UEs) are provided between the source station 910 (e.g., a base station or gNB) and the destination station 930 (e.g., a UE). Specifically, FIG. 9 only show two relay nodes A and B to represent a series of consecutive relay nodes 920. In the procedure 900, the latency to be measured of the packet transmission may be further classified into per link latency, per link set latency and per path latency. In other words, the latency to be measured by the UEs (e.g., the relay nodes 920 and the destination station 930) may be identified as being performed on per link and/or per link set and/or per path of packet transmission.

As shown in FIG. 9, the latency may be measured by the source station 910, the relay nodes 920 (e.g., relay nodes A and B) and/or the destination station 930 during the process when the source station 910 transmits a packet toward the relay node A, the relay node A continues to forward the packet through multiple consecutive relay nodes to the relay node B, and the relay node B forwards packet to the destination station 930. Specifically, the entire packet transmission latency from the source station 910 to the destination station 930 is classified as per path latency. The packet transmission latency between two neighbor nodes (e.g., between the source station 910 and the relay node A, or between the relay node B and the destination station 930) is classified as per link latency. The packet transmission latency between two nodes that are connected to each other through one or multiple relay nodes (e.g., between the relay nodes A and B through other relay nodes therebetween) is classified as per link set latency, where the link set represents the set of multiple consecutive transmission links. A transmission path is composed of one/multiple link(s) or one/multiple link set(s) or any combination between link(s) and link set(s). Similarly, per path latency is composed of one/multiple per link latency or one/multiple per link set latency or any combination between per link and per link set latency.

One issue related to the latency measurement is the timing to measure the latency on each node/station. In certain configurations, the latency measurement may be performed per packet. Alternatively, in certain configurations, the latency measurement may be performed periodically on the packets or on the slots with a (pre-)configured period. Further alternatively, in certain configurations, the latency measurement may be performed by a triggering event.

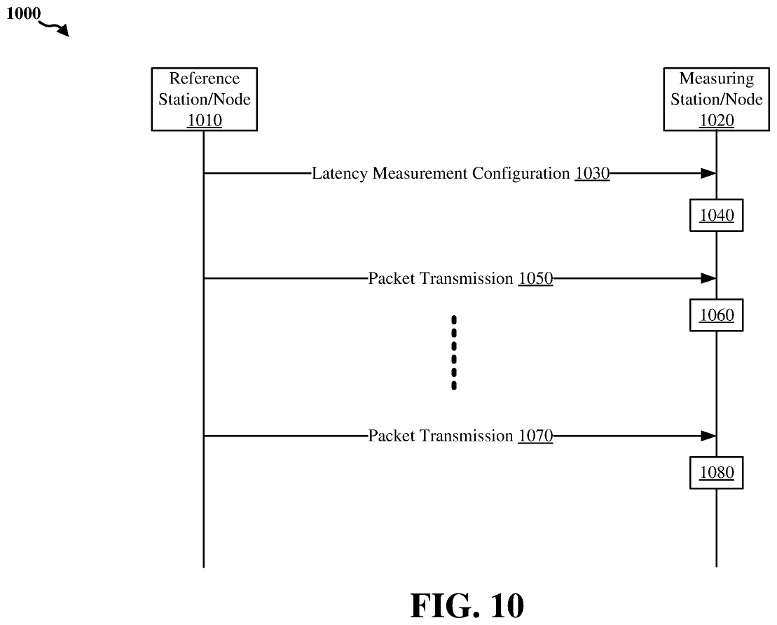

FIG. 10 is a diagram illustrating an example procedure of performing latency measurement per packet. The procedure 1000 shows the latency measurement to be performed per packet, in which a measuring station/node 1020, which may be a relay node or the destination station, is connected to a reference station/node 1010, which may be the source station or a relay node, such that the measuring station/node 1020 performs latency measurement based on each packet transmitted by the reference station/node 1010.

As shown in FIG. 10, the reference station/node 1010 transmits a latency measurement configuration 1030 to the measuring station/node 1020 for setting up the latency measurement performed by the measuring station/node 1020. Specifically, the latency measurement configuration 1030 may be a (pre-)configuration on the latency measurement of the measuring station/node 1020 indicating that the latency measurement is performed per packet. In certain configurations, the latency measurement configuration 1030 may be generated by the network (e.g., the source station) and forwarded to the measuring station/node 1020 through the reference station/node 1010. In certain configurations, the latency measurement configuration 1030 may be transmitted in a RRC message, a Medium Access Control (MAC) Control Element (CE) command or a PDCCH. At operation 1040, the measuring station/node 1020 configures the latency measurement according to the latency measurement configuration 1030.

At operation 1050, the reference station/node 1010 performs packet transmission (e.g., transmitting a packet to the measuring station/node 1020). At operation 1060, the measuring station/node 1020 measures the latency of the packet received. In certain configurations, the packet being transmitted and measured may be a control packet or a data packet. At operation 1070, the reference station/node 1010 performs another packet transmission. At operation 1080, the measuring station/node 1020 measures the latency of the packet received. The latency measurement operations repeat whenever a packet transmission occurs between the reference station/node 1010 and the measuring station/node 1020.

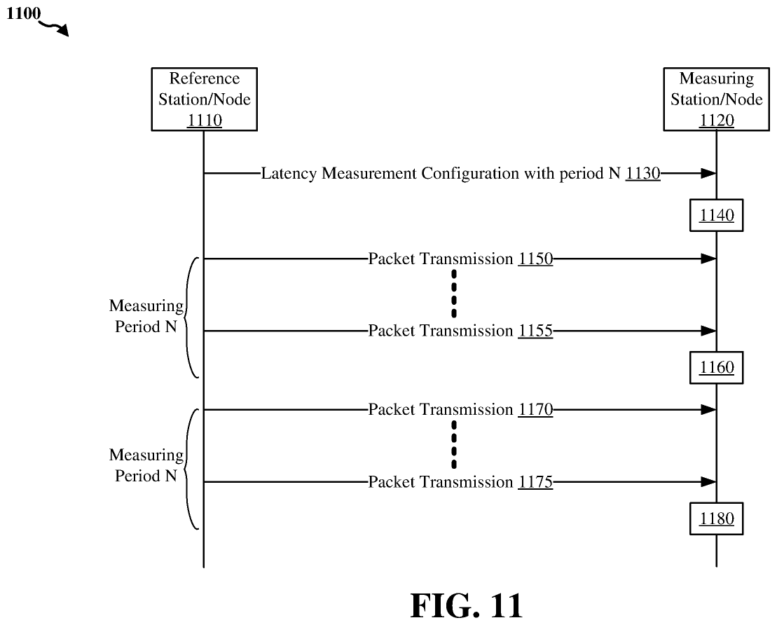

FIG. 11 is a diagram illustrating an example procedure of performing latency measurement periodically on the packets. The procedure 1100 shows the latency measurement to be performed periodically with a measuring period N, in which a measuring station/node 1120, which may be a relay node or the destination station, is connected to a reference station/node 1110, which may be the source station or a relay node, such that the measuring station/node 1120 performs latency measurement periodically based on the packets transmitted by the reference station/node 1110 within each measuring period N.

As shown in FIG. 11, the reference station/node 1110 transmits a latency measurement configuration 1130 to the measuring station/node 1120 for setting up the latency measurement performed by the measuring station/node 1120. Specifically, the latency measurement configuration 1130 may be a (pre-)configuration on the latency measurement of the measuring station/node 1120 indicating that the latency measurement is performed periodically with the measuring period N. In certain configurations, the latency measurement configuration 1130 may be generated by the network (e.g., the source station) and forwarded to the measuring station/node 1120 through the reference station/node 1110. In certain configurations, the latency measurement configuration 1130 may be transmitted in a RRC message, a MAC CE command or a PDCCH. At operation 1140, the measuring station/node 1120 configures the latency measurement according to the latency measurement configuration 1130.

At operations 1150 to 1155, the reference station/node 1110 performs a series of packet transmissions (e.g., transmitting a plurality of packets to the measuring station/node 1120) within the measuring period N. At operation 1160, the measuring station/node 1120 measures the latency of the packets received within the measuring period N. In certain configurations, each packet being transmitted and measured may be a control packet or a data packet. At operations 1170 to 1175, the reference station/node 1110 performs another series of packet transmissions within another measuring period N. At operation 1180, the measuring station/node 1120 measures the latency of the packet received within the measuring period N. The latency measurement operations repeat periodically between the reference station/node 1110 and the measuring station/node 1120.

In certain configurations, the latency measurement configuration (e.g., latency measurement configuration 1030 or 1130) may include one or more fields including: information of a measurement period (e.g., the measuring period N for the measuring station/node to perform latency measurement on the packets in the procedure 1100), information of a measurement object (e.g., the corresponding link/link set/path to perform the latency measurement, which may be indicated by a starting station ID and an ending station ID), information of a measurement method, information of a measurement packet (e.g., the packet ID or traffic to be measured), information of a measurement station (e.g., the station ID of the measuring station/node to perform the latency measurement), and other related information.

In certain configurations, even if the latency measurement configuration is not transmitted by the reference station/node, the measuring station/node may still self-trigger the latency measurement by itself for scheduling/path selection/optimization purposes.

As described, the latency measurement configuration may include the information of the measurement method. In certain configurations, various methods may be used for performing latency measurement by the measuring station/node (e.g., a relay node or the destination station). For example, one method for measuring the latency involves using a timestamp inserted in each packet being transmitted. In certain configurations, the timestamp may be carried by the packet through the protocol layer 2 and/or the protocol layer 3, for example, within the PDCP layer, the adaptation layer (e.g., SRAP layer), or the IP layer. For each respective packet, the timestamp represents the timing when the source station generates the corresponding header of each respective packet, or the timing when a relay node forwards each respective packet.

In certain configurations, the format and granularity of the timestamp may depend on the timing synchronization source of the stations (e.g., the source station, the relay node(s) and the destination station). For example, in one embodiment. the stations within the packet transmission path are synchronized with a common reference source (e.g., a higher layer IEEE 1588 PTP protocol, GNSS). In this case, the latency measurement timestamp adapts the same format and granularity of the common reference source. In another embodiment, the stations within the packet transmission path are synchronized on an individual link with local link clock sources, e.g., the NR subframe number (SFN) or the sidelink direct frame number (DFN). In this case, the latency measurement timestamp adapts the format and granularity of the timestamp insertion station (e.g., the reference station/node 1010 or 1110). In a further embodiment, in the topology mixing with the above-mentioned clock sources, the timestamp may adapt the format of the common reference source or the local link clock source if the receiving node (e.g., the measuring station/node 1020 or 1120) is also synchronized to the same source.

In certain configurations, with the timestamp being inserted in each packet, the measuring station/node may perform the latency measurement by extracting the timestamp from the packet received, and deriving/calculating the timing difference between the timestamp retrieved from the packet and a current timestamp. As a result, the latency (which may be per link, per link set or per path latency) is measured.

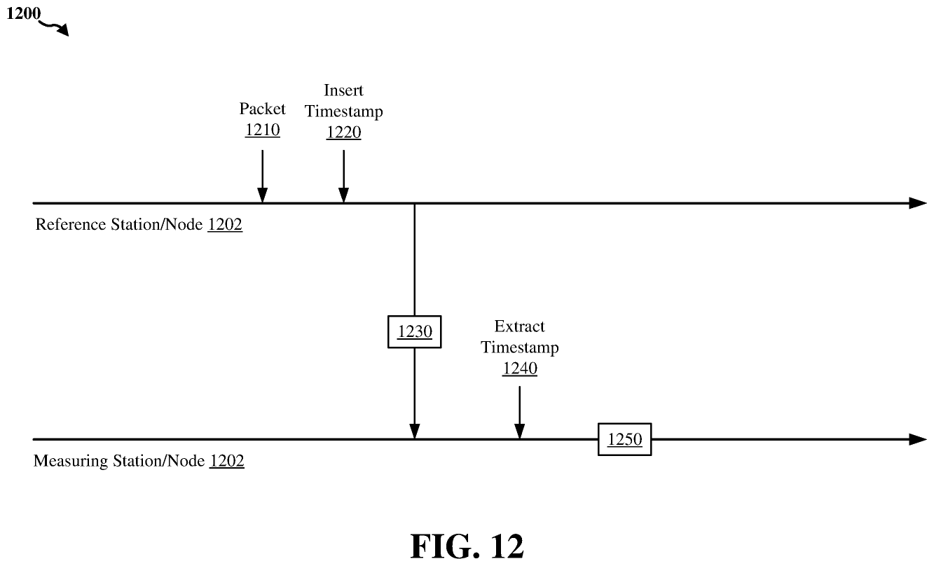

FIG. 12 is a diagram illustrating an example procedure of performing latency measurement using a timestamp in each packet. The procedure 1200 shows a reference station/node 1202 (e.g., reference station/node 1010 or 1110), which may be the source station or a relay node, inserting a timestamp in the packet to be transmitted to a measuring station/node 1204 (e.g., measuring station/node 1020 or 1120), which may be a relay node or the destination station.

As shown in FIG. 12, at operation 1210, the reference station/node 1202 obtains a packet to be transmitted. Specifically, the reference station/node 1202 may be a source station, which generates the packet to be transmitted, or may be a relay node, which receives the packet from a connecting station/node (e.g., the source station or a previous connecting relay node). At operation 1220, the reference station/node 1202 inserts a timestamp in the packet (e.g., through the protocol layer 2 and/or the protocol layer 3). At operation 1230, the reference station/node 1202 performs the packet transmission to transmit the packet with the timestamp to the measuring station/node 1204. Upon receiving the packet, at operation 1240, the measuring station/node 1204 extracts the timestamp from the packet received. At operation 1250, the measuring station/node 1204 calculates the timing difference between the timestamp retrieved from the packet and a current timestamp to measure the latency.

Another method to measure latency by the measuring station/node is to record a packet transmission latency of each packet. Specifically, the station/node measures the packet latency by recording the timing of transmission/reception of first terabyte (TB) of the packet and transmission/reception of last TB of the packet. By subtracting the recording timing difference on MAC and/or PHY, the packet latency of the corresponding transmission path may be measured without inserting the timestamp in the packet.

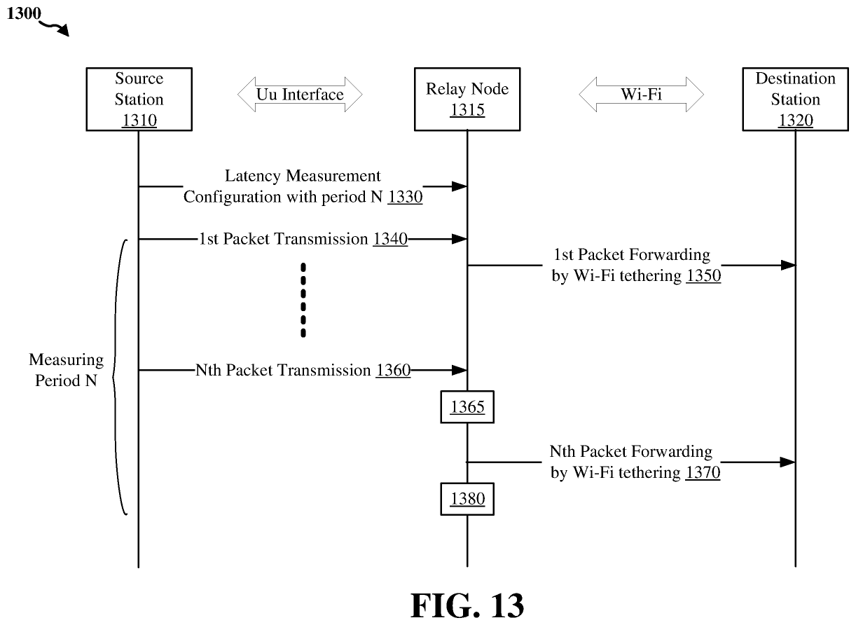

FIG. 13 is a diagram illustrating an example procedure of performing latency measurement by recording the packet transmission latency. The procedure 1300 shows the latency measurement to be performed periodically with a measuring period N by a relay node 1315 (i.e., the measuring station/node) between a source station 1310 and a destination station 1320, where the relay node 1315 performs the latency measurement by recording a transmission start point of the packet and counting the latency when the packet transmission ends. Specifically, similar to the procedure 700 as shown in FIG. 7, the source station 1310 is connected to the relay node 1315 through the Uu interface, and the relay node 1315 is connected to the destination station 1320 through the Wi-Fi tethering connection.

As shown in FIG. 13, the source station 1310 transmits a latency measurement configuration 1330 to the relay node 1315 for setting up the latency measurement performed by the relay node 1315. Specifically, the latency measurement configuration 1330 may be a (pre-)configuration on the latency measurement of the relay node 1315 (as the measuring station/node) indicating that the latency measurement is performed periodically with the measuring period N. In certain configurations, the latency measurement configuration 1330 may be transmitted in a RRC message, a MAC CE command or a PDCCH. Upon receiving the latency measurement configuration 1330, the relay node 1315 configures the latency measurement according to the latency measurement configuration 1330.

Within a measuring period N, the source station 1310 performs a series of packet transmissions (e.g., transmitting a plurality of packets) to the relay node 1315. Specifically, at operation 1340, the source station 1310 performs the first packet transmission to the relay node 1315. Upon receiving the first packet, at operation 1350, the relay node 1315 performs the first packet forwarding to by Wi-Fi tethering to forward the first packet to the destination station 1320. The packet transmission process continues within the measuring period N, and at operation 1360, the source station 1310 performs the N-th packet transmission to the relay node 1315. Upon receiving the N-th packet, at operation 1365, the relay node 1315 sets a latency counting start point, in which the relay node 1315 starts recording the timing of the start point (e.g., the timing at the start of the forwarding transmission of the N-th packet). At operation 1370, the relay node 1315 performs the N-th packet forwarding to by Wi-Fi tethering to forward the N-th packet to the destination station 1320. At operation 1380, at the latency counting end point (e.g., the end of the forwarding transmission of the N-th packet), the relay node 1315 performs the latency measurement by calculating the timing difference between the start point and the end point, thus obtaining the latency without the timestamp.

In certain configurations, when the packet is transmitted through a relay node, the relay node may be provided with a relay function, and the relay function within the relay node is triggered when the relay node forwards the packet(s) to the next receiving station/node (e.g., the destination station or the next relay node). Specifically, the relay function, when triggered, may perform one or more corresponding actions to the packet(s) received. Examples of the actions performed by the relay function may include, without being limited thereto, timestamp conversion, timestamp extraction and insertion, routing information conversion, and packet early drop.

In the timestamp conversion action, the relay node converts the timestamp from the packet received to the format that the following receiving station is synchronized with the relay node. In certain configurations, the timestamp conversion may be performed by a formula (1) as follows:

$${Timestamp\_}_{𝔫odeB} = a \times {Timestamp\_}_{nodeA} + b \qquad ( 1 )$$

where the parameter a represents a timestamp conversion ratio, and the parameter b represents an offset. In certain configurations, the parameters (i.e., the timestamp conversion ratio a and the offset b) are maintained between the two neighboring nodes (e.g., nodes A and B), and the neighboring nodes may exchange their timestamps periodically in order to update the parameters. Alternatively, the relay node may provide the parameters (i.e., the timestamp conversion ratio a and the offset b) to the next hopping node, such that the next hopping node may perform the timestamp conversion accordingly.

In the timestamp extraction and insertion action, the relay node extracts the timestamp from the packet received, and inserts it to another protocol layer to preserve the timing information if the forwarding link uses different radio access technology from the previous link.

In the routing information conversion action, the relay node retrieves the routing information from the packet received, and converts it to the format that may be recognized by the forwarding link (e.g., the receiving station). For example, the relay node may retrieve the routing information in the SRAP layer from the packet received and converts it into the IP header of the packet.

In the packet early drop action, the relay node checks the latency by the timestamp in the packet received as a current packet transmission latency, and compared the current packet transmission latency with the PDB or a latency threshold. If the current packet transmission latency is out of PDB or the latency threshold, the packet may be early dropped. Whenever a packet is early dropped by the relay node, a packet early dropping ratio is statistically collected by the relay node. The packet early dropping ratio is finally reported to the source station in order to improve packet transmission reliability performance.

In the actions performed by the relay function as described above, the timestamp conversion, timestamp extraction and insertion and packet early drop actions require the timestamp to be used in the latency measurement. However, the routing information conversion action may be used in the case where the time stamp is used in the latency measurement, or in the case where latency measurement is performed by recording the packet transmission latency.

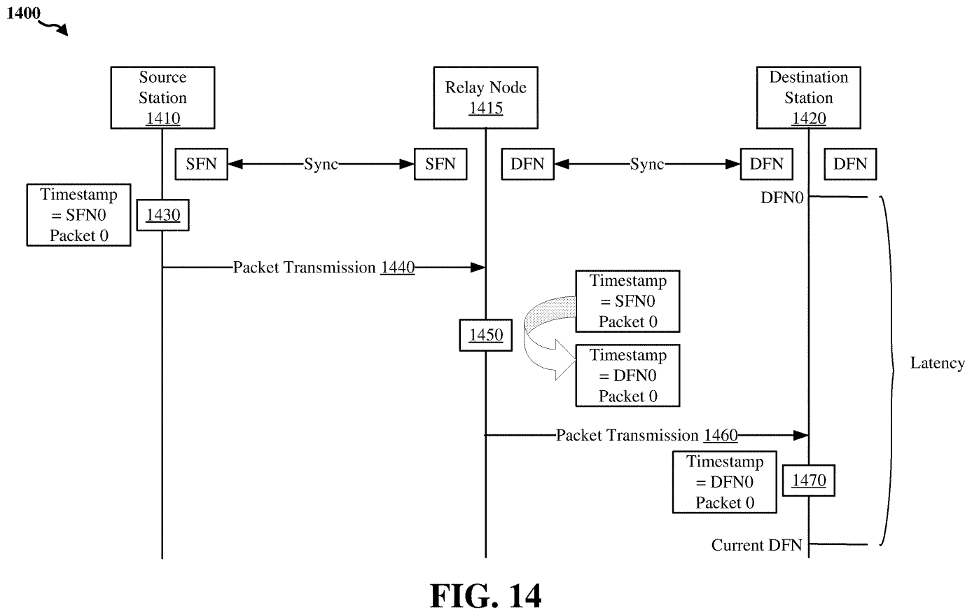

FIG. 14 is a diagram illustrating an example procedure of performing latency measurement by the timestamp in a single hop scenario, where the hopping node is synchronized to the source station and the destination station individually by local link clock source. The procedure 1400 shows the latency measurement to be performed by a destination station 1420 (i.e., the measuring station/node) being connected to a source station 1410 through a relay node 1415 in a single hop scenario, where the relay node 1415, as the hopping node, is locally synchronized with the source station 1410 by NR link SFN, and is locally synchronized with the destination station 1420 by the sidelink link DFN. In other words, the relay node 1415 is synchronized to the source station 1410 and the destination station 1420 individually by local link clock source.

As shown in FIG. 14, at operation 1430, the source station 1410 generates a packet (hereinafter the “packet 0”) to be transmitted, and inserts a timestamp that equals to SFN0 in the packet 0. At operation 1440, the source station 1410 transmits the packet 0 to the relay node 1415. Upon receiving the packet 0, at operation 1450, the relay node 1415 triggers the relay function to perform timestamp conversion by converting the SFN value (i.e., SFN0) of the timestamp in the packet 0 to a corresponding DFN value (i.e., DFN0) of the clock source on the packet forwarding link. At operation 1460, the relay node 1415 transmits/forwards the packet 0 to the destination station 1420. Upon receiving the packet 0, at operation 1470, the destination station 1420 performs latency measurement by extracting the timestamp, which has the value of DFN0, from packet 0, and calculates the latency as a time difference between the start time indicated by the timestamp (i.e., DFN0) and the current DFN. In other words, the latency measured by the destination station 1420 is (current DFN−DFN0).

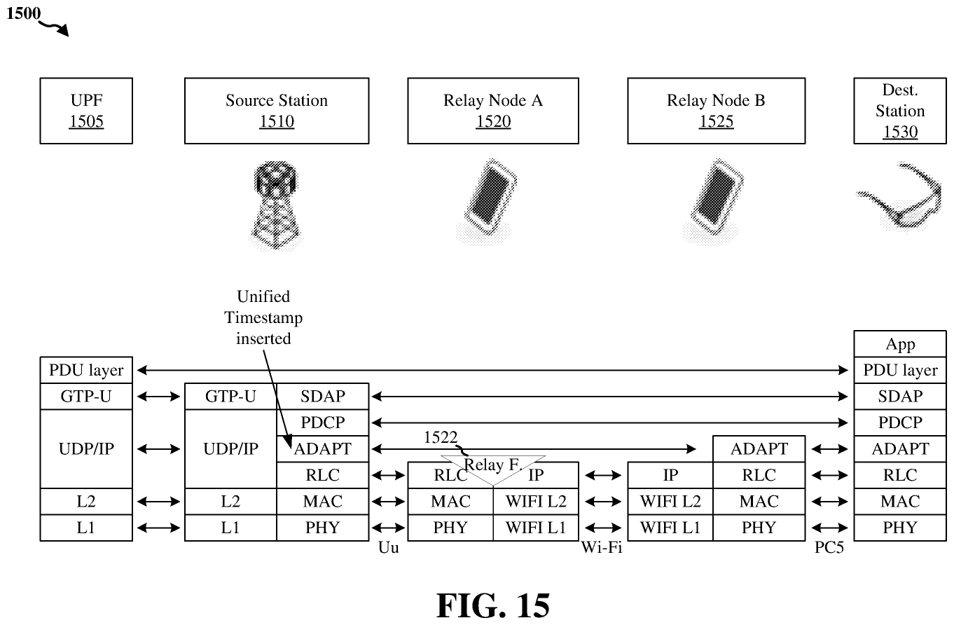

FIG. 15 is a diagram illustrating an example procedure of performing latency measurement by the timestamp in a multi-hop scenario, where the hopping nodes are synchronized by unified timestamps. The procedure 1500 adopts a multi-hop scenario, with two hopping nodes 1520 and 1525 (e.g., relay nodes A and B) are provided between the source station 1510 and the destination station 1530, and the hopping nodes 1520 and 1525 are synchronized by unified timestamps. The destination station 1530 functions as the measuring station/node in the procedure 1500.

As shown in FIG. 15, the source station 1510 is connected to the relay node A 1520 through the Uu interface, the relay node A 1520 is connecting to the relay node B 1525 through Wi-Fi, and the relay node B 1525 is connecting to the destination station 1530 through the PC5 interface. The network configures the latency measurement period to be per packet measuring, and the latency measurement path to be per path measuring. The latency is measured by the timestamp.

Specifically, to measure the per path latency, the source station 1510 inserts a unified timestamp into the adaptation layer, and forwards the packet to the relay node A 1520. The relay node A 1520 triggers the relay function 1522 while receiving the packet from the source station 1510 for performing the routing information conversion action. Specifically, inside the relay function 1522, the adaptation header is decoded, and the Layer 2 routing information is extracted. The relay function 1522 then transforms the Layer 2 routing information into corresponding IP routing information and puts it into the IP header of a new generated IP packet. The entire Adaptation packet with the timestamp information in its header is preserved in the IP payload of the IP packet generated. Then, the relay node A 1520 forwards the IP packet generated through IP tunneling by Wi-Fi to the relay node B 1525. The relay node B 1525 decodes the IP packet received and retrieves the preserved Adaptation packet. Then, the relay node B 1525 forwards the Adaptation packet to the destination station 1530 through the PC5 interface. The destination station 1530 receives the packet routed from the source station 1510 and gets the packet with the timestamp. Thus, the per path transmission latency may be derived by the timing difference of the unified timestamp received and a current timestamp at the destination station 1530.

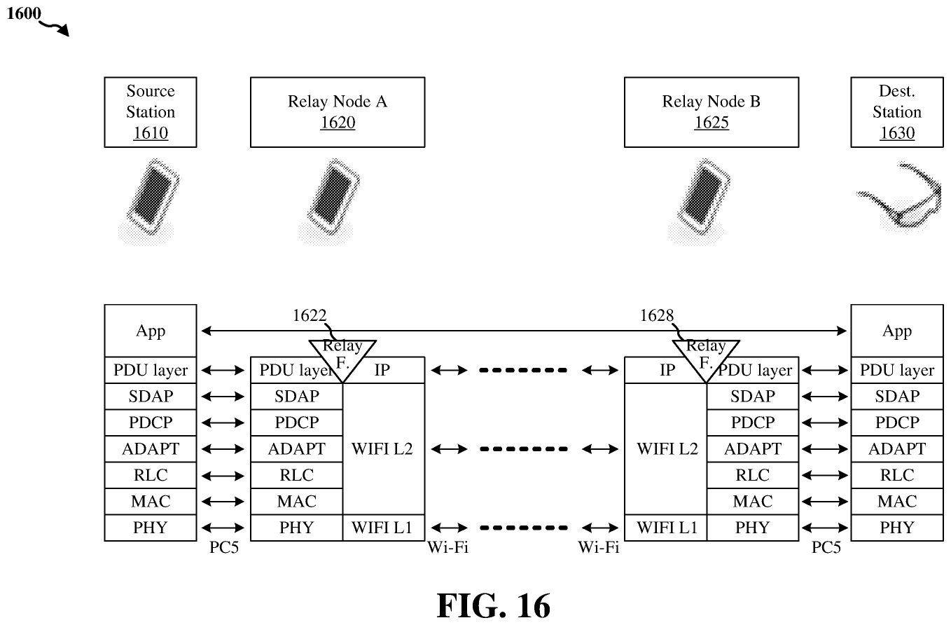

FIG. 16 is a diagram illustrating an example procedure of performing latency measurement by the timestamp in a multi-hop scenario, where per link set latency is measured. The procedure 1600 adopts a multi-hop scenario, with multiple hopping nodes (e.g., relay nodes) are provided between the source station 1610 and the destination station 1630. It should be noted that the source station 1610 as shown in FIG. 16 is a UE. Specifically, only two of the hopping nodes 1620 and 1625 (i.e., relay nodes A and B) are shown in FIG. 16. Among the hopping nodes (including the relay nodes A and B and all relay nodes therebetween), some of the hopping nodes are synchronized through a unified PTP timestamps, and some of the hopping nodes are synchronized through the local link clock source. The relay node B 1625 functions as the measuring station/node in the procedure 1600.

As shown in FIG. 16, the source station 1610 (e.g., a UE) is connecting to the destination station 1630 through the relay node A 1620 and the relay node B 1625. The source station 1610 is linked to the relay node A 1620 through the PC5 interface. The relay node A 1620 is connecting to the relay node B 1625 through several Layer 3 non-3GPP hopping nodes, where the Layer 3 non-3GPP hopping nodes is unknown by the source station 1610. The relay node B 1625 is linked to the destination station 1630 through the PC5 interface. The source station 1610 configures the latency measurement period to be per packet measuring, and latency measurement path to be per link set measuring, where the link set is configured to be the links between the relay node A 1620 and the relay node B 1625. The latency is measured by the timestamp.

Specifically, the source station 1610 firstly transmits the packet to the relay node A 1620. To measure the per link set latency, the relay function 1622 of the relay node A 1620 is triggered to perform the timestamp extraction and insertion action. In particular, the relay node A 1620 inserts a unified PTP timestamp into the IP header and forwards the packet through the IP transport layer by Wi-Fi. The IP packet goes through several non-3GPP hopping nodes and arrives at the relay node B 1625. Based on the latency measurement configuration, the relay function 1628 of the relay node B 1625 gets the timestamp information in the IP header and derives the per link set latency between the relay node A 1620 and the relay node B 1625 by calculating the timing difference between the timestamp and a current timestamp at the relay node B 1625. The relay node B 1625 then continues to forward the packet to the destination device 1630 through the PC5 interface.

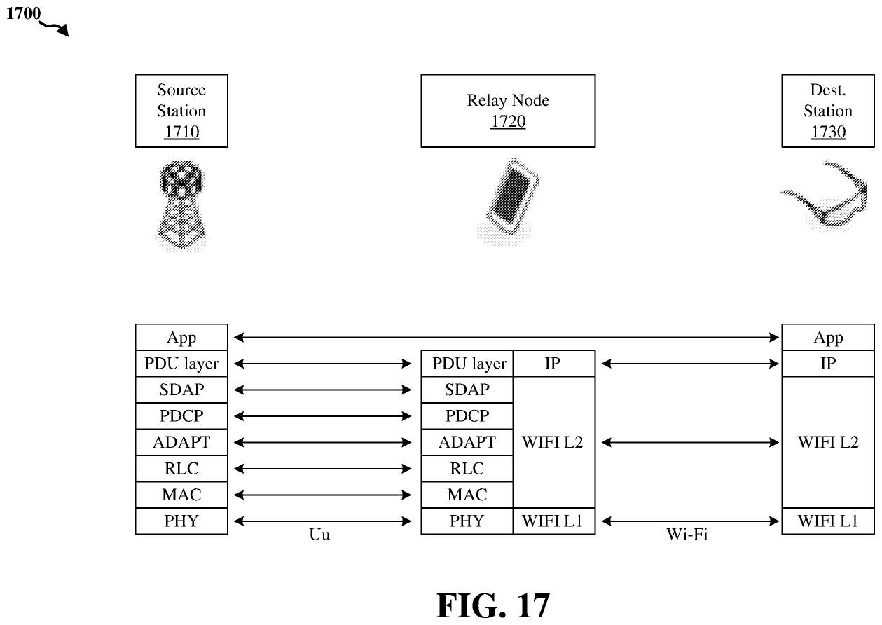

FIG. 17 is a diagram illustrating an example procedure of performing latency measurement by the self-recorded packet transmission delay in a tethering scenario. The procedure 1700 shows the latency measurement to be performed by a destination station 1730 (e.g., XR glasses) being connected to a source station 1710 (e.g., gNB) through a relay node 1720 (e.g., a smartphone) in a single hop scenario. The relay node 1720 functions as the measuring station/node in the procedure 1700.

As shown in FIG. 17, the source station 1710 is connecting to the destination device 1730 through the relay node 1720. The source station 1710 is linked to the relay node 1720 through the Uu interface, and the relay node 1720 is connecting to the destination device 1730 through Wi-Fi. The network configures the latency measurement period to be periodically measured on the timing interval, and the latency measurement path to be per link measuring, where the link is configured between the relay node 1720 and the destination station 1730.

Specifically, the source station 1710 transmits the packet to the relay node 1720. The relay node 1720 forwards the packet to the destination station 1730. At the configured latency measuring period, the relay node 1720 records a timing as the counting start point before packet forwarding. Then, the relay node 1720 transmits the corresponding packet through Wi-Fi tethering. Once the packet transmission is done (either by finishing the initial transmission or receiving an ACK feedback from the destination station 1730), the latency is measured by the relay node 1720 by calculating the timing difference between the counting start point and the packet transmission end point.

In certain configurations, the latency measurement report may be generated by various methods. Specifically, a latency measuring station/node, after performing the latency measurement, may generate the latency measurement report for reporting the latency information to other report receiving stations (e.g., the relay node(s) and/or the source station. Specifically, the latency measurement report may be encapsulated in and transmitted via the RRC message, the MAC CE command or a physical UL control channel (PUCCH). In certain configurations, the latency measurement report may be transmitted/reported periodically on slot with a (pre-)configured period and/or when (pre-)configured reporting criteria/threshold is fulfilled (e.g., when measured latency exceeds configured reporting threshold), and/or by a network triggering event.

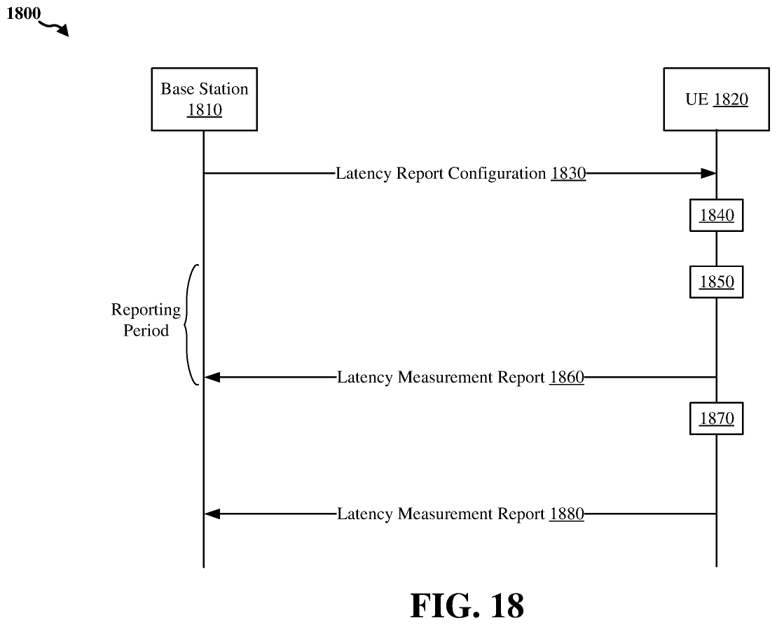

FIG. 18 is a diagram illustrating an example procedure of a UE transmitting the latency measurement report periodically. The procedure 1800 shows the latency measurement report to be transmitted periodically, in which a UE 1820, as the reporting node, is connected to a base station 1810 (e.g., gNB), which may be the source station, such that the UE 1820 transmitted the latency measurement report periodically to the base station 1810.

As shown in FIG. 18, the base station 1810 transmits a latency report configuration 1830 to the UE 1820 for setting up the configuration for the latency measurement report generated/transmitted by the UE 1820. Specifically, the latency report configuration 1830 may be a (pre-)configuration on the latency measurement report generated by the UE 1820 indicating that the latency measurement report is transmitted periodically with a reporting period. In certain configurations, the latency report configuration 1830 may be generated by the base station 1810 and forwarded to the UE 1820 through one or more relay nodes. In certain configurations, the latency report configuration 1830 may be transmitted in a RRC message, a MAC CE command or a PDCCH. At operation 1840, the UE 1820 configures the operations of the latency measurement report according to the latency report configuration 1830.

At operation 1850, at the start of the reporting period, the UE 1820 generates the latency measure report with the latency of the packet(s) measured in the latency measurement. At the end of the reporting period, the UE 1820 transmits the latency measurement report 1860 to the base station 1810. At operation 1870, at the start of another reporting period, the UE 1820 again generates another latency measure report with the latency of the packet(s) measured in the latency measurement. At the end of the reporting period, the UE 1820 transmits the latency measurement report 1880 to the base station 1810. In certain configurations, the UE 1820 may also transmit the latency measurement reports 1860 and 1880 to other report receiving station(s).

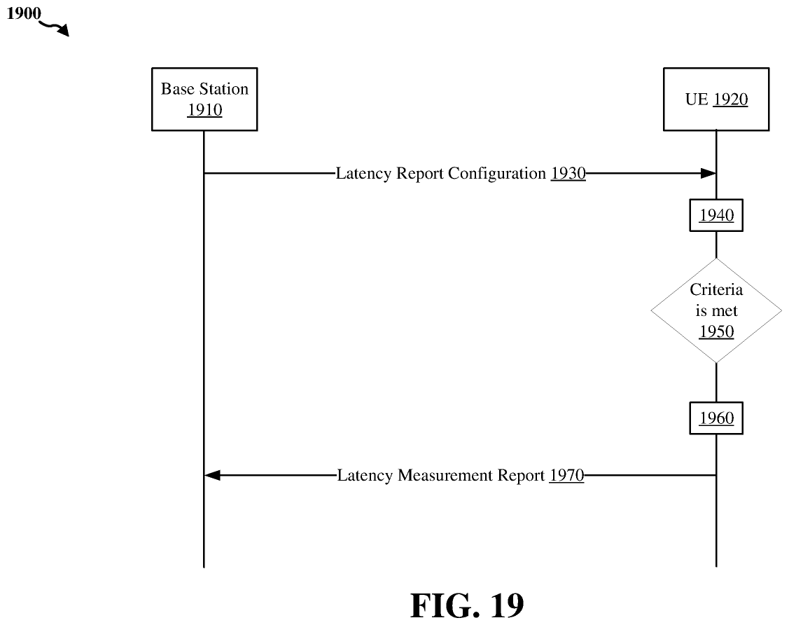

FIG. 19 is a diagram illustrating an example procedure of a UE transmitting the latency measurement by a triggering event. The procedure 1900 shows the latency measurement report to be transmitted according to a (pre-)configured reporting criteria as the triggering event. Specifically, a UE 1920, as the reporting node, is connected to a base station 1910 (e.g., gNB), which may be the source station, such that the UE 1820 transmitted the latency measurement report to the base station 1910 according to the triggering event, i.e., the reporting criteria is met.

As shown in FIG. 19, the base station 1910 transmits a latency report configuration 1930 to the UE 1920 for setting up the configuration for the latency measurement report generated/transmitted by the UE 1920. Specifically, the latency report configuration 1930 may be a (pre-)configuration on the latency measurement report generated by the UE 1920 indicating that the latency measurement report is transmitted according to the triggering event. In certain configurations, the latency report configuration 1930 may be generated by the base station 1910 and forwarded to the UE 1920 through one or more relay nodes. In certain configurations, the latency report configuration 1930 may be transmitted in a RRC message, a MAC CE command or a PDCCH. At operation 1940, the UE 1920 configures the operations of the latency measurement report according to the latency report configuration 1930.

At operation 1950, the UE 1920 determines that a triggering event occurs, e.g., the reporting criteria is met. Upon being triggered by the triggering event, at operation 1960, the UE 1920 generates the latency measure report with the latency of the packet(s) measured in the latency measurement. Then, the UE 1920 transmits the latency measurement report 1970 to the base station 1910. In certain configurations, the UE 1920 may also transmit the latency measurement report 1970 to other report receiving station(s).

In certain configurations, the latency report configuration (e.g., the latency report configuration 1830 or the latency report configuration 1930) may be transmitted via a RRC message, a MAC CE command or a PDCCH. In certain configurations, the latency report configuration may include one or more fields including: information of a reporting mode, which indicates if the reporting is performed periodically or based on event; information of a reporting period, which indicates the reporting time period if the reporting is set to be performed periodically; information of a reporting criteria, which indicates the reporting criteria as the triggering event if the reporting is set to be an event-based report (e.g., if a latency threshold is set to be reporting criteria, the report is triggered when the measured latency is greater than the latency threshold); information of a timer, which may be used to avoid frequent reporting if the event-based report is configured; and information of the latency report receiving station, which indicates if the latency report is distributed to the source station and/or other report receiving station(s).

In certain configurations, the latency information carried in the latency measurement report may include one or more fields including information of an activation of a tethering mode and the latency of the packet(s) being measured. Specifically, the information of the activation of the tethering mode may be a 1-bit field to indicate whether the reporting UE (e.g., the destination device) is serving through the tethering mode or not.

In certain configurations, the contents of the latency of the packet(s) being measured in the latency measurement report may include one or more fields including: an identification of the latency measured, information of the packet(s) being measured, the latency characteristics, the latency value, and an average throughput. Specifically, the identification of the latency measured may include information indicating the latency as the per path latency, per link set latency and/or per link latency, as well as an identity of the measurement starting station and an identity of the measurement ending station. For the packet(s) being measured, the information of each packet may be classified by the packet ID, the packet size, the traffic flow ID, and/or the QoS classification of the packet. In certain configurations, each packet being measured is also classified as a control packet or a data packet.

In certain configurations, the latency characteristics may be expressed in one or more statistical values, including: an average latency of N previous measured packet latencies, or a maximum/minimum latency of N previous measured packet latencies, where N is a (pre-)configured number or a number determined by the total number of packet latencies measured within the reporting period; the jitter of the packet latency; or a standard deviation of the previously measured latencies.

In certain configurations, the latency value(s) being reported may be represented in one of the following formats, including: the (pre-)configured granularity (e.g., for the 30 ms latency with the granularity set as 5 ms, the latency value is reported as 6); the absolute value (e.g., in milliseconds); a delta value to the PDB (e.g., for the 30 ms latency with the PDB equal to 20 ms, the latency value is reported as +10 ms); and a range value (e.g., the range of the latency variation value).

In certain configurations, the average throughput being reported may be the average throughput of the latency measuring link/link set/path. In one embodiment, the average throughput is estimated by an average value of the amount of data packet bits divided by the latency.

In certain configurations, the latency measurement report may further include side information, such as other information related to tethering. e.g., the UE buffer status to indicate queueing on the tethering path, the LBT latency or channel busy ratio if unlicensed, the transmission failure rate (reliability), and/or a channel quality report of the tethering path.

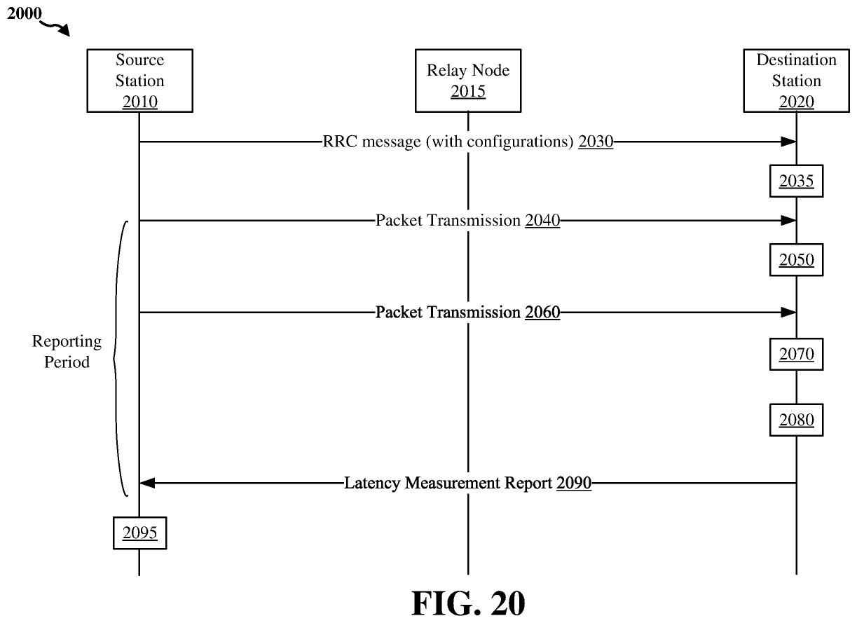

FIG. 20 is a diagram illustrating an example procedure of a UE performing the latency measurement and transmitting the latency measurement report. Specifically, the procedure 2000 shows a combination of the procedures between a source station 2010 (e.g., gNB) and a destination station 2020 (e.g., UE) through a relay node 2015 (e.g., UE) in a Layer 2 relay scenario, in which the destination station 2020 performs latency measurement and generates/transmits the latency measurement report to the source station 2010 through the Layer 2 relay of the relay node 2015.

As shown in FIG. 20, the source station 2010 transmits a RRC message 2030 to the destination station 2020 through the relay node 2015. Specifically, the RRC message 2030 carries the latency measurement configuration and the latency report configuration for the destination station 2020. For example, the source station 2010 sets up the latency measurement configuration with per packet measurement, and the measuring method to be with the timestamp sets. Further, the source station 2010 sets up the latency report configuration by setting the reporting mode to be a periodic report and setting the reporting latency to be true (i.e., enabling the latency measurement report). At operation 2035, the destination station 2020, upon receiving the RRC message 2030, configures the latency measurement and the latency reporting according to the latency measurement configuration and the latency report configuration in the RRC message 2030.

Once the configuration is complete, the source station 2010 may start transmitting data packets to the destination station 2020 through the relay node 2015, such that the destination station 2020 may perform latency measurement and latency reporting. Specifically, at operation 2040, the source station 2010 transmits a data packet to the destination station 2020 through the relay node 2015. At operation 2050, the destination station 2020, based on the latency measurement configuration, starts to perform latency measurement to measure the packet transmission latency for the packet based on the timestamp in each packet. At operation 2060, the source station 2010 transmits another data packet to the destination station 2020 through the relay node 2015. At operation 2070, the destination station 2020, based on the latency measurement configuration, starts to perform latency measurement to measure the packet transmission latency for the packet based on the timestamp in the packet. At operation 2080, upon latency reporting period, the destination station 2020 calculates the average latency by averaging previous measurement latency result within the reporting period, and generates the latency measurement report by setting the tethering mode to be true and setting the latency value as the delta value of the PDB in the report. Then, the destination station 2020 transmits the latency measurement report 2090 to the source station 2010 through the relay station 2015 at the end of the reporting period. At operation 2095, the source station 2010, upon receiving the latency measurement report 2090, performs transmission reconfiguration/adaption according to the contents of the latency measurement report 2090.

As described above, when the source station receives the latency measurement report, the source station may perform corresponding transmission reconfiguration/adaption according to the contents of the latency measurement report. In certain configurations, the transmission reconfiguration/adaption may be performed by a relay node and/or the source station (e.g., gNB) and/or the network in order to fulfill the latency requirement of the traffic (e.g., the PDB) and to improve the user experience.

In certain configurations, examples of the reconfiguration/adaptation schemes may include codec rate adaptation, link adaptation, adaptive scheduling, path selection/switching, and routing decision. In certain configurations, the schemes may be performed independently or jointly. For example, in one embodiment, the source station (e.g., gNB) may reconfigure the codec rate to meet the PDB requirements. In another embodiments, the source station (e.g., gNB) may reconfigure the codec rate and performs link adaption jointly. It should be noted that the concepts of reconfiguration and adaptation are inter-exchangeable for adjusting the transmission property according to the assistance latency information in the latency measurement report. In one embodiment, the reconfiguration options are referred to semi-state adjustment and adaptation options are referred to dynamic adjustment.

In certain configurations, the codec rate adaptation triggered by reception of the latency measurement report is to adjust the source encoder behavior, including one or more actions as follows to increase/reduce data rate: frame per second (FPS) adjustment, and packet size adjustment. In certain embodiments, the codec rate adaptation may be configured/signaled through RAN messages (e.g., RRC messages) or high-layer protocols, such as the IP Multimedia Subsystem (IMS) protocol.

In certain configurations, the link adaptation triggered by reception of the latency measurement report may include one or more actions as follows to reduce/increases packet transmission latency based on the latency measurement report received: Quadrature Amplitude Modulation (QAM) table adjustment, Modulation and Coding Scheme (MCS) adjustment, and multiple-input multiple-output (MIMO) rank adjustment.

In certain configurations, the adaptive scheduling triggered by reception of the latency measurement report may include one or more actions as follows to reduce/increase packet transmission latency based on the received latency report: Case SL model (e.g., reconfiguring grant resources/resource pool); Case SL mode2 (e.g., reconfiguring resource selection window, and/or reconfiguring resource pool period); and Case power saving (e.g., enabling/disabling power saving related features to shorten/relax packet transmission timing, such as SL partial sensing and/or DRX; enabling/disabling features to condense/prolong packet transmission duration, such as BWP and/or CA).

In certain configurations, the path selection/switching and/or link selection/switching and/or link set selection/switching triggered by reception of the latency measurement report allows the triggering station (e.g., the source station, a relay node or a UE) to switch to the path that fulfills the traffic latency requirement. In one embodiment, a UE may switch the UL packet transmission path from the indirect path (e.g., the tethering link) to the direct path (e.g., the Uu link) when the latency of the indirect path exceeds the PDB requirement. In another embodiment, a base station (gNB) may switch the DL packet transmission path from the direct path to the indirect path when the latency measurement report received for the indirect path fulfills PDB requirement.

In certain configurations, the routing decision triggered by reception of the latency measurement report allows the triggering station to improve packet routing decision to fulfill traffic latency requirement. Specifically, the packet routing is described as follows.

In one embodiment, the routing path may be configured in advanced by the source station or the network. Specifically, upon reception of the latency measurement report, the source station or the network updates the per link/link set/path latency of the current routing topology and reconfigures the packet routing path. In certain configurations, if the packet early dropping ratio is reported from the relay node or the destination station to the source station/network, the source station/network may reconfigure the packet routing path when the packet early dropping ratio is out of the reliability requirement.

In another embodiment, the routing path is decided locally by each hopping node. For example, each hopping node decides the next hopping node to forward the packet to until the packet arrives at the destination station. The routing decision is made according to the routing algorithm and assistance information of each hopping node on its own. Specifically, upon reception of the latency measurement report, the hopping nodes update the per link/link set/path latency of the current routing topology for routing algorithm decision making.

In certain configurations, the routing/switching decision may be performed on per link level, per link set level, per path level or combination of link/link set/path levels. Examples of the routing decision algorithm may be described in several different embodiments. In one embodiment, each packet has different path transmission depends on traffic requirement and dynamic latency reporting information. In another embodiment, different packet has different routing path to prioritize traffic or to offload traffic load to multiple paths. In yet another embodiment, the packets are routed through the path with shortest latency.

In certain configurations, the station that receives the latency measurement report from other stations may record the latency according to the packet transmission topology. In one embodiment, the packet transmission path is composed by several links and link sets. In this case, the latency related to each link/link set is recorded. For example, a path A is composed by ({link 1, latency 1}, {link set 2, latency 2}). In another embodiment, the mesh topology is break down into multiple per link/link set/path components, e.g., link 1, link 2, link set 1, link set 2. If the reported latency of a link/link set is out of the latency requirement targeted for the link/link set, the link/link set is reconfigured as an unavailable component. As a result, any packet routing path that went through the unavailable link/link set needs to be reconfigured with the new routing path or to trigger a relay node reselection event.

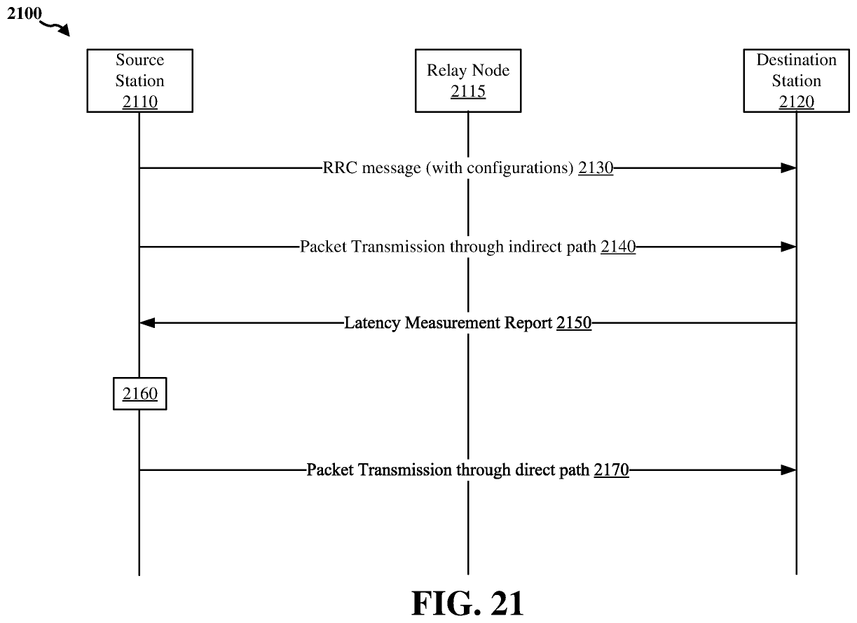

FIG. 21 is a diagram illustrating an example procedure of a source station performing transmission reconfiguration upon receipt of the latency measurement report. In the procedure 2100, a destination station 2120 under a multi-path scenario is introduced, in which the destination station 2120 maintains connections to a source station 2110 (e.g., gNB) through a direct path and an indirect path (i.e., through a relay node 2115).

As shown in FIG. 21, the source station 2110 transmits a RRC message 2130 to the destination station 2120 to set up the latency measurement configuration and the latency report configuration. Specifically, the source station 2110 transmits the RRC message 2130 to the destination station 2120 through the relay node 2115 (i.e., the indirect path), and the latency measurement configuration and the latency report configuration in the RRC message 2130 indicates that the packets will be transmitted in the indirect path, and the destination station 2120 will reports the packet transmission latency of the indirect path. At operation 2140, the source station 2110 transmits data packets to the destination station 2120 through the relay node 2115. Based on the configurations (i.e., the latency measurement configuration and the latency report configuration), the destination station 2120 measures packet transmission latency, and at operation 2150, the destination station 2120 transmits the latency measurement report for reporting the packet transmission latency of the indirect path. At operation 2160, upon receiving the latency measurement report from the destination station 2120, the source station 2110 performs the path switching decision as the transmission reconfiguration/adaptation. Specifically, the source station 2110 may decide, based on the latency information of the indirect path in the latency measurement report, to reconfigure data transmission path to the direct path in order to fulfill the packet transmission latency requirement. At operation 2170, after the path switching decision, the source station 2110 transmits the upcoming packets through the direct path to the destination station 2120.

In certain configurations, the latency measurement are performed on the packets. Specifically, for each packet being used for the latency measurement, two types of the packet are possible: a control packet (e.g., a ping packet) for latency measurement, and a data packet for latency measurement. In certain configurations, the control packet may be a MAC CE control packet or a PDCP control packet. Specifically, the control packet used for latency measurement allows latency measuring with fix small bits packet. The latency measured on the control packet may reflect channel queueing latency, buffering latency, intra-station processing latency and/or channel access latency of the measured link/link set/path. In certain configurations, the measured latency may be considered as the minimum expected hopping/relaying latency of the measured link/link set/path.

On the other hand, a data packet may also be a used for latency measurement. The latency measured on the data packet may reflect channel queueing latency, buffering latency, intra-station processing latency, inter-station transmission latency, channel access latency and the latency of time duration needed to download data on channel of the measured link/link set/path. In certain configurations, the latency of time duration needed to download data on channel may vary due to channel quality.

In certain configurations, by performing latency measurement on both the control packets and the data packets, the measuring station/node may collect a complete latency information on the measured link/link set/path. Specifically, the queueing latency and the processing latency are collected by control packet measurement. The latency of time duration needed to download data on channel is collected by the delta between measurement results of the data packets and the control packets. Furthermore, with the bits number of the data packets, the measuring station may estimate an average channel throughput of the measured link/link set/path. Finally, with the assisted information of minimum expected hopping/relaying latency and average channel throughput, the station that received the assisted information may perform transmission reconfiguration (e.g, per link/link set/path selection) considering the packet size to be transmitted.

In one embodiment, when a station has a data packet of a large packet size to be transmitted, the station may calculate the expected packet transmission latency on a candidate path by summing up the minimum expected hopping/relaying latency of the path and a time duration needed to download data on channel based on the average channel throughput of the path. The station may then select the path with the smallest latency summation value as the packet transmission path.

In another embodiment, when a station has a control packet of a small packet size to be transmitted, the station may consider the expected packet transmission latency on a candidate path by the minimum expected hopping/relaying latency of the path. The station may then select the path with the smallest latency value as the packet transmission path.

In certain configurations, centralized and decentralized methods of the transmission reconfiguration may be provided. Specifically, the UE-assisted latency measurement and report for the tethering/multi-hop/mesh topology may be further categorized into two function modes: a centralized (coordinated) mode or a decentralized mode.

In certain configurations, under the centralized mode, a central control station/node of tethering/multi-hop/mesh topology is provided to send the latency measurement configuration and the latency report configuration to one or several station(s)/node(s) of the topology. In this case, the station(s)/node(s) appointed to perform the latency measurement may send the latency measurement report back to central control station/node based on the configurations. The central control station/node may then make the transmission reconfiguration decision for station(s)/node(s) of the topology based on the received assisted latency measurement report. In one embodiment, a central control node/station indicates a neighboring node A to switch its packet forwarding node as a routing decision based on the assisted latency information. The neighboring node A then reactively follows the instruction given by the central control station/node and reconfigures its packet forwarding node.

In certain configurations, under the decentralized mode, each station and/or node measures latency proactively to collect packet latency information. Specifically, the measuring station and/or node may perform the transmission reconfiguration based on their measuring results. The measuring station and/or node may generate the assisted latency measurement report and sent(s) the assisted latency measurement report to other node(s)/station(s) of the tethering/multi-hop/mesh topology. Based on the assisted latency measurement report received from other node(s)/station(s) of the topology, a node/station may perform the transmission reconfiguration. In one embodiment, a node/station may proactively and dynamically select a packet forwarding node as routing decision based on its measured latency and assisted latency report received from neighbor nodes.

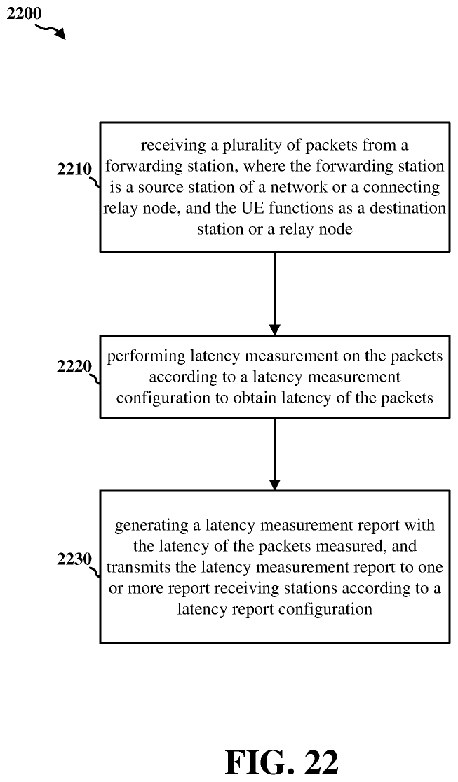

FIG. 22 is a flow chart of a method (process) for wireless communication of a UE. The procedure 2200 may be performed by a UE, which may function as a destination station (e.g., destination station 730, 830, 930, 1320, 1420, 1530, 1630, 1730, 1820, 1920, 2020 or 2120) or a relay node (e.g., relay nodes 720, 820, 920, 1315, 1415, 1520, 1525, 1620, 1625, 1720, 2015 or 2115). At procedure 2210, the UE receives a plurality of packets from a forwarding station. The forwarding station is a source station of a network or a connecting relay node, and the UE functions as a destination station or a relay node. At procedure 2220, the UE performs latency measurement on the packets according to a latency measurement configuration to obtain latency of the packets. At procedure 2230, the UE generates a latency measurement report with the latency of the packets measured, and transmits the latency measurement report to one or more report receiving stations according to a latency report configuration.

In certain configurations, the UE further receives, from the forwarding station, the latency measurement configuration and the latency report configuration. The latency measurement configuration and the latency report configuration may be received in a RRC message, a MAC CE command or a PDCCH.

In certain configurations, each respective packet received includes a timestamp representing a timing when the source station generates a header of each respective packet, or a timing when a relay node forwards each respective packet. The UE extracts the timestamp from each respective packet. The UE performs the latency measurement by calculating a timing difference between the timestamp extracted and a current timestamp. In one embodiment, the timestamp is extracted from a protocol layer 2 or a protocol layer 3 of each respective packet.

In certain configurations, the UE functions as the relay node. The UE triggers a relay function within the relay node, where the relay function performs one or more actions to the packets received. The UE forwards the packets received to a receiving station, where the receiving station is the destination station or a next relay node. In certain embodiments, the actions performed by the relay function include: converting the timestamp from each of the packets received to a format that the receiving station is synchronized with the relay node; extracting the timestamp from each of the packets received, and inserting the timestamp extracted to a different protocol layer of each of the packet; retrieving routing information from the packets received, and converting the routing information to a format recognized by the receiving station; and in response to determining, based on the timestamp of a corresponding packet of the packets, that a current packet transmission latency is out of a PDB or a latency threshold, performing early dropping of the corresponding packet, and collecting statistic information of a packet early dropping ratio.

In certain configurations, the UE receives a second latency measurement report from a connecting station. In response to receiving the second latency measurement report, the UE performs transmission reconfiguration according to the second latency measurement report.

In certain configurations, the UE performs the latency measurement by recording a packet transmission latency of each of the packets.

In certain configurations, the latency measurement report is encapsulated and transmitted to the one or more report receiving stations in a RRC message, a MAC CE command or a PUCCH.

In certain configurations, the latency measurement report is transmitted periodically, or the latency measurement report is transmitted when a reporting criteria is met, or the latency measurement report is transmitted according to a triggering event.

In certain configurations, the latency measurement report includes at least one of: the latency of the packets measured, an identifier of the packets measured, and an identifier of a link or a link set or a path measured.

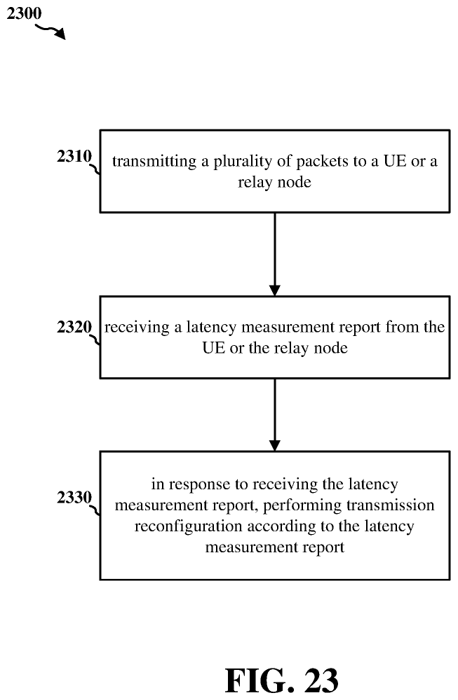

FIG. 23 is a flow chart of a method (process) for wireless communication of a source station of a network. The procedure 2300 may be performed by a source station (e.g., a base station, gNB) of a network, e.g., source station 710, 810, 910, 1310, 1410, 1510, 1610, 1710, 1810, 1910, 2010 or 2110. At procedure 2310, the source station transmits a plurality of packets to a UE or a relay node. At procedure 2320, the source station receives a latency measurement report from the UE or the relay node. At procedure 2330, in response to receiving the latency measurement report, the source station performs transmission reconfiguration according to the latency measurement report.

In certain configurations, the source station transmits, to the UE or the relay node, a latency measurement configuration and a latency report configuration. The latency measurement configuration and the latency report configuration may be received in a RRC message, a MAC CE command or a PDCCH.

In certain configurations, each of the packets is a control packet or a data packet.

In certain configurations, the latency measurement is performed on per link and/or per link set and/or per path of packet transmission.

In certain configurations, the transmission reconfiguration includes at least one of: codec rate adaptation, link adaptation, adaptive scheduling, path selection/switching or link selection/switching, and routing decision.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving a plurality of packets from a forwarding station, wherein the forwarding station is a source station of a network or a connecting relay node, and the UE functions as a destination station or a relay node;
performing latency measurement on the packets according to a latency measurement configuration to obtain latency of the packets; and
generating a latency measurement report with the latency of the packets measured, and transmitting the latency measurement report to one or more report receiving stations according to a latency report configuration.

2. The method of claim 1, further comprising:
receiving, from the forwarding station, the latency measurement configuration and the latency report configuration,
wherein the latency measurement configuration and the latency report configuration are received in a radio resource control (RRC) message, a Medium Access Control (MAC) Control Element (CE) command or a physical downlink control channel (PDCCH).

3. The method of claim 1, wherein each of the packets is a control packet or a data packet.

4. The method of claim 1, wherein the latency measurement is performed on per link and/or per link set and/or per path of packet transmission.

5. The method of claim 1, wherein each respective packet of the packets received includes a timestamp representing a timing when the source station generates a header of the each respective packet, or a timing when a relay node forwards the each respective packet.

6. The method of claim 5, further comprising:
extracting the timestamp from the each respective packet; and
performing the latency measurement by calculating a timing difference between the timestamp extracted and a current timestamp.

7. The method of claim 6, wherein the timestamp is extracted from a protocol layer 2 or a protocol layer 3 of the each respective packet.

8. The method of claim 5, wherein the UE functions as the relay node, and the method further comprises:
triggering a relay function within the relay node, wherein the relay function performs one or more actions to the packets received; and
forwarding the packets received to a receiving station, wherein the receiving station is the destination station or a next relay node.

9. The method of claim 8, wherein the one or more actions performed by the relay function include:
converting the timestamp from each of the packets received to a format that the receiving station is synchronized with the relay node;
extracting the timestamp from each of the packets received, and inserting the timestamp extracted to a different protocol layer of each of the packet;
retrieving routing information from the packets received, and converting the routing information to a format recognized by the receiving station; and
in response to determining, based on the timestamp of a corresponding packet of the packets, that a current packet transmission latency is out of a packet delay budget (PDB) or a latency threshold, performing early dropping of the corresponding packet, and collecting statistic information of a packet early dropping ratio.

10. The method of claim 8, further comprising:
receiving a second latency measurement report from a connecting station; and
in response to receiving the second latency measurement report, performing transmission reconfiguration according to the second latency measurement report.

11. The method of claim 1, further comprising:
performing the latency measurement by recording a packet transmission latency of each of the packets.

12. The method of claim 1, wherein the latency measurement report is encapsulated and transmitted to the one or more report receiving stations in a radio resource control (RRC) message, a Medium Access Control (MAC) Control Element (CE) command or a physical uplink control channel (PUCCH).

13. The method of claim 1, wherein the latency measurement report is transmitted periodically, or the latency measurement report is transmitted when a reporting criteria is met, or the latency measurement report is transmitted according to a triggering event.

14. The method of claim 1, wherein the latency measurement report includes at least one of:
the latency of the packets measured,
an identifier of the packets measured, and
an identifier of a link or a link set or a path measured.

15. A method of wireless communication of a source station of a network, comprising:
transmitting a plurality of packets to a UE or a relay node;
receiving a latency measurement report from the UE or the relay node; and
in response to receiving the latency measurement report, performing transmission reconfiguration according to the latency measurement report.

16. The method of claim 15, further comprising:
transmitting, to the UE or the relay node, a latency measurement configuration and a latency report configuration,
wherein the latency measurement configuration and the latency report configuration are transmitted in a radio resource control (RRC) message, a Medium Access Control (MAC) Control Element (CE) command or a physical downlink control channel (PDCCH).

17. The method of claim 15, wherein each of the packets is a control packet or a data packet.

18. The method of claim 15, wherein each respective packet of the packets received includes a timestamp representing a timing when the source station generates a header of the each respective packet.

19. The method of claim 15, wherein the latency measurement report is encapsulated and received in a radio resource control (RRC) message, a Medium Access Control (MAC) Control Element (CE) command or a physical uplink control channel (PUCCH).

20. The method of claim 15, wherein the transmission reconfiguration includes at least one of:
codec rate adaptation,
link adaptation,
adaptive scheduling,
path selection/switching or link selection/switching, and
routing decision.
